(19) United States
(12) Patent Application Publication
(10) Pub. No.: US 2025/0278292 A1
(43) Pub. Date: Sep. 4, 2025

(54) PIPELINED COMPUTE DISPATCH PROCESSING

(71) Applicant: Advanced Micro Devices, Inc., Santa Clara, CA (US)

(72) Inventors: Alexander Fuad Ashkar, Orlando, FL (US); Manu Rastogi, Orlando, FL (US); Lisa Lorraine Saturday, Orlando, FL (US); Harry J. Wise, Orlando, FL (US); Joseph L. Greathouse, Austin, TX (US); Rex E. McCrary, Orlando, FL (US)

(73) Assignee: Advanced Micro Devices, Inc., Santa Clara, CA (US)

(21) Appl. No.: 18/592,125

(22) Filed: Feb. 29, 2024

(51) Int. Cl. G06F 9/48

(52) U.S. Cl. CPC G06F 9/4843

(57) ABSTRACT

A technique is provided for improving throughput and latency for processing command queue entries that describe work to be performed for compute kernels. The technique includes processing the command queue entries and, instead of directly configuring hardware that spawns workgroups for compute kernel execution, storing work dispatch descriptor entries that describe how to spawn the workgroups. These work dispatch descriptor entries allow a work dispatch controller that spawns the workgroups to work at a different rate than the command queue processor which processes the command queue entries, which helps to reduce latency of execution.

### BACKGROUND

Devices such as graphics processing units accept requests to perform work, process such requests, and configure internal state to begin processing such work. It is possible for processing such requests to be a bottleneck itself that prevents the requested work from being performed as quickly as possible.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 provides additional details about the command processor, according to an example;

FIG. 4 is a diagram of a command queue, according to an example;

FIG. 5 illustrates an example of the command queue processor generating a work dispatch descriptor entry based on a command queue entry;

FIG. 6 illustrates the work dispatch controller generating workgroups for the compute units;

FIGS. 7A-7B illustrate operations for generating workgroups for execution while also writing work dispatch descriptor entries into the work dispatch descriptor queue; and

FIG. 8 is a flow diagram of a method for executing compute kernels on an APD, according to an example.

### DETAILED DESCRIPTION

A technique is provided for improving throughput and latency for processing command queue entries that describe work to be performed for compute kernels. The technique includes processing the command queue entries and, instead of directly configuring hardware that spawns workgroups for compute kernel execution, storing work dispatch descriptor entries that describe how to spawn the workgroups. These work dispatch descriptor entries allow a work dispatch controller that spawns the workgroups to work at a different rate than the command queue processor which processes the command queue entries, which helps to reduce latency of execution.

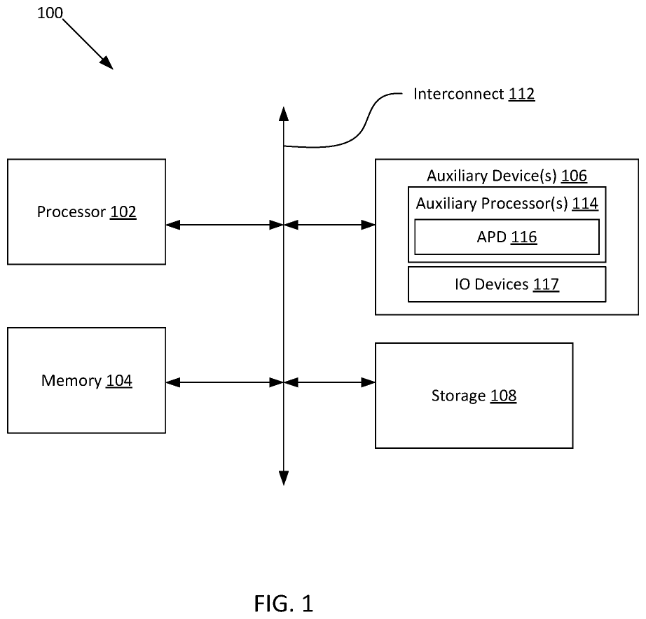

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction multiple thread paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

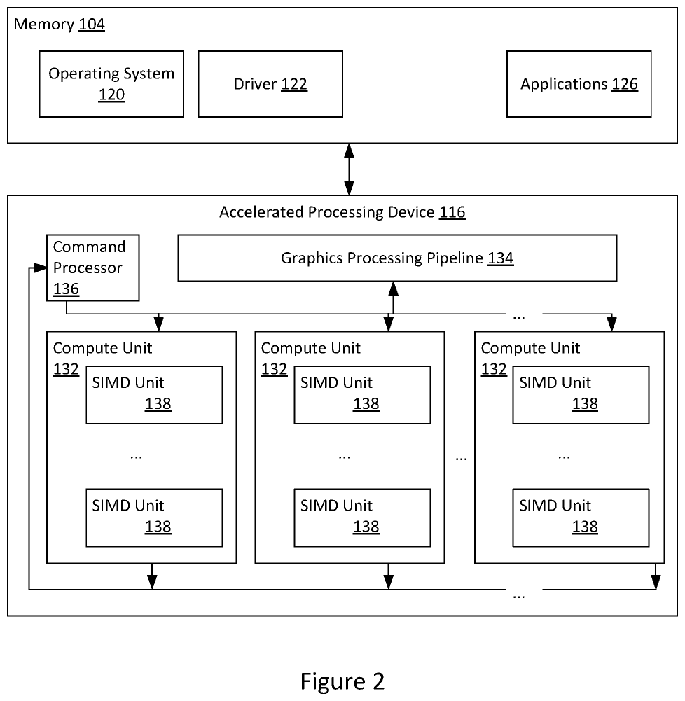

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, neural computing, artificial intelligence (AI) tasks or other tasks, based on commands received from the processor 102.

In this example, the APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations as well as various compute or Al operations. Thus in some instances, a graphics processing pipeline 134, which accepts graphics processing commands from the processor 102, provides computation tasks to the compute units 132 for execution in parallel. Although a graphics processing pipeline 134 is illustrated in FIG. 2, the disclosure provided herein applies to APDs 116 that do not include a graphics processing pipeline 134.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

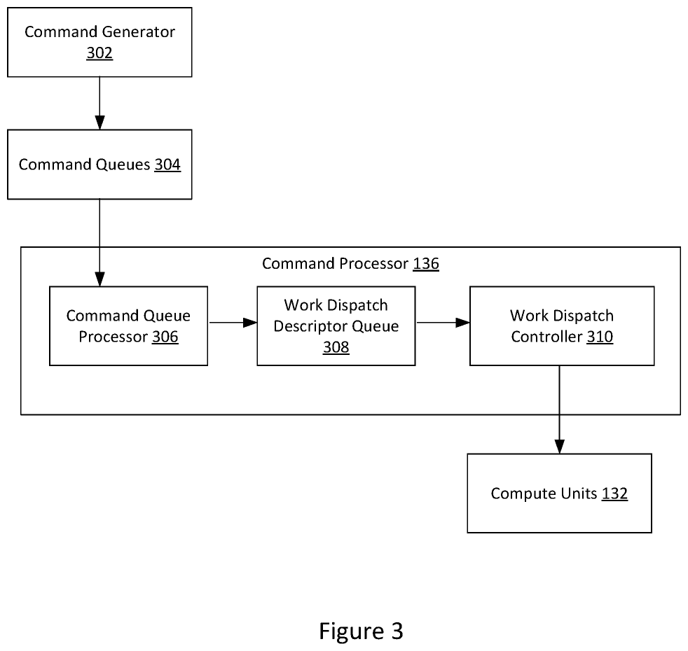

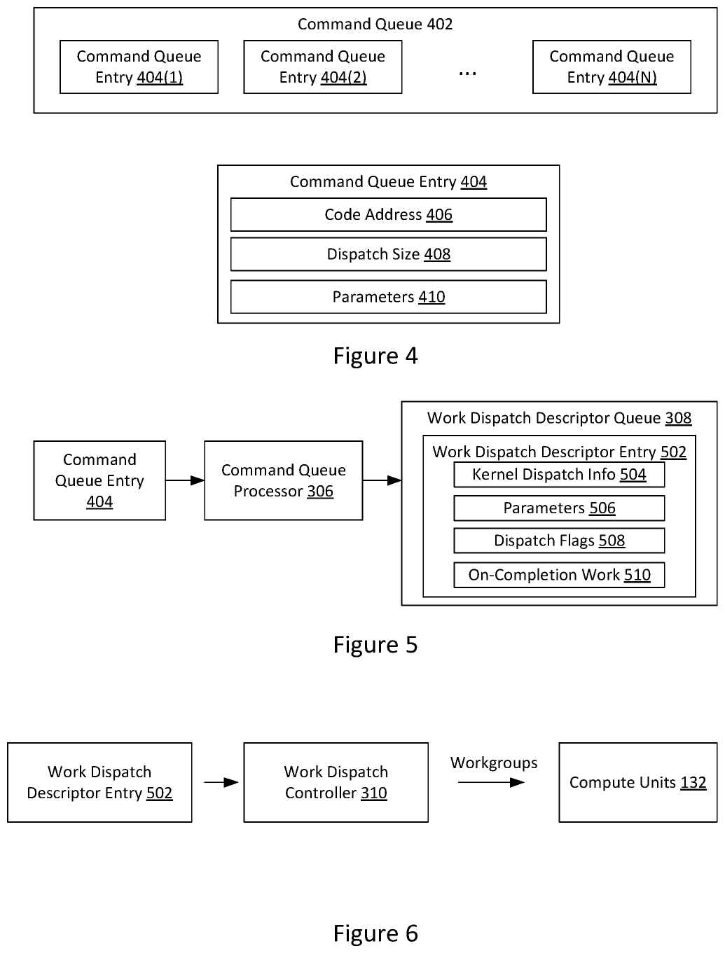

FIG. 3 provides additional details about the command processor 136, according to an example. In FIG. 3, a command generator 302 generates commands for placement into the command queues 304. In various examples, the command generator 302 is the processor 102 (e.g., a CPU), the APD 116 itself (in which case, the APD 116 is generating commands for itself), or any other technically feasible processor or entity. In some examples, these commands are commands to perform compute operations (e.g., general purpose graphics processing unit (“GPGPU”) operations). Example compute operations include operations to execute compute kernels. A compute kernel is a general purpose computing program executable on the APD 116. In various examples, the commands for placement into the command queues include commands that specify what compute kernel (e.g., what computer code) is to be executed as well as parameters for such execution. In various examples, such parameters include one or more of the number of workgroups to be spawned to execute the compute kernel. In some examples, the compute kernel itself (that is, the program code for the compute kernel) specifies the number of work items for each workgroup. In some examples, the parameters include arguments for the compute kernels, execution modes for the compute kernels, or any other items specified elsewhere herein, such as with respect to the parameters 410 of FIG. 4. In summary, the command generator 302 generates commands such as commands to execute compute kernels that specify various parameters for such execution, and places those commands into the command queues 304 for processing by the command processor 136. The command processor 136 examines the commands and configures the APD 116 to execute the commands as specified.

In greater detail, the command processor 136 includes a command queue processor 306, a work dispatch descriptor queue 308, and a work dispatch controller 310. The command queue processor 306 processes commands in the command queues 304, converting the commands into entries in the work dispatch descriptor queue 308. The work dispatch controller 310 retrieves the entries in the work dispatch descriptor queue 308 and generates workgroups for execution by the compute units 132 based on the entries of the work dispatch descriptor queue 308.

The above configuration of the command processor 136 allows the work dispatch controller 310 to work at a different rate than the command queue processor 306, which improves performance. More specifically, without the work dispatch descriptor queue 308, the command queue processor 306 would be able to provide information about one command of the command queues 304 and then would be able to work on a second, subsequent command. However, if the command queue processor 306 completed processing the second command and the work dispatch controller 310 was still generating workgroups for the immediately previous command (“a first command”), the command queue processor 306 could not move onto a third command subsequent to the second command, as the command queue processor 306 would not be able to retain the information for the second command for the work dispatch controller 310. In other words, the command queue processor 306 would be able to work at most one command ahead of the work dispatch controller 310. The work dispatch descriptor queue 308 thus allows the command queue processor 306 to work significantly ahead of the work dispatch controller 310 by allowing the command queue processor 306 to store processing results in the work dispatch descriptor queue 308.

FIG. 4 is a diagram of a command queue 402, according to an example. The command queues 304 of FIG. 3 includes one or more command queues 402. Each command queue 402 includes one or more command queue entries 404 (N such entries are shown in FIG. 4). Each command queue entry 404 includes an indication of what compute kernel is to be executed (e.g., by including the address of the beginning of the code for such compute kernel), what arguments are to be passed to that kernel, and how many work-items are to execute the compute kernel. In some examples, the arguments include constants, pointers to (e.g., memory) locations to be used as inputs or outputs, or any other indication of data to be used as input or output for the compute kernel. In some examples, the indication of how many work-items are to execute the compute kernel includes an indication of a number of workgroups to execute the computer kernel and the number of work-items in each such workgroup. In some examples, an entity such as the processor 102 or APD 116 itself generates a command queue entry 404 as a request for the APD 116 to perform the work identified by the command queue entry 404. In an example, software executing on the processor 102 executes one or more functions of an general purpose graphics processing unit (“GPGPU”) application programming interface (“API”) to generate a command queue entry 404 and place that command queue entry 404 into a software queue. Then, the APD 116 maps that software queue to a hardware command queue (which is one of the command queues 402) and executes commands from that hardware command queue.

An example command queue entry 404 is illustrated. As described, the command queue entry includes a code address 406 (the address of the beginning of code for the compute kernel), an indication of a dispatch size 408, and a set of parameters 410. The code address 406 is the “indication of what compute kernel is to be executed” described above. The dispatch size 408 is the indication of “how many work-items to execute the compute kernel” described above. The set of parameters 410 includes the “arguments to be passed to the kernel” described above. Together, the contents of the example command queue entry 404 of FIG. 4 define a compute kernel dispatch that describes a set of work to be performed. More specifically, a compute kernel dispatch, or sometimes just a “kernel dispatch” herein, refers to an instance of execution of a particular compute kernel, with a given number of work-items and set of parameters. A kernel dispatch is complete when all workgroups for the kernel dispatch have been created and execution for such workgroups is complete.

FIG. 5 illustrates an example of the command queue processor 306 generating a work dispatch descriptor entry 502 based on a command queue entry 404. The command queue processor 306 reads the command queue entry 404 and generates information for the work dispatch descriptor entry 502, including kernel dispatch info 504, a set of parameters 506, a set of dispatch flags 508, and a set of on-completion work 510.

The kernel dispatch info 504 includes the code address 406 of the command queue entry 404. Again, the code address 406 describes the starting location of the code for the compute kernel. In addition, the kernel dispatch info 504 includes information for the configuration of the workgroups to be launched. In general, such information includes information that indicates the manner in which the execution of the workgroups will occur in the compute units 132. In some examples, such configuration information includes the types of floating point exceptions that can occur, the floating point rounding mode, and other information. The kernel dispatch info 504 also includes a kernel dispatch size, which indicates a number of work-items per workgroup and a number of workgroups to create. In some examples, info from the command queue entry 404 such as the code address 406 are transformed from the format of the command queue entry 404 to a format that is suitable for the work dispatch descriptor entry 502.

The parameters 506 include the parameters 410 of the command queue entry 404. In various examples, the parameters 506 are derived from information in the command queue entry 404 such as information directly specified within that entry 404 or information referenced by the command queue entry 404 (e.g., via a pointer) and stored at a different location, such as any location accessible by the command queue processor 306. It is possible that some of the values in the parameters 506 are derived from a different command queue entry 404 than the entry 404 for which the work dispatch descriptor entry 502 is being generated. It is also possible for data to be obtained from a data queue rather than a command queue. In addition, the parameters 506 include initial state of the registers for the work-items being executed. More specifically, each work-items has access to a number of registers to access as a scratch space. The parameters 410 indicate what data those registers are initialized to. Examples of such data include constant values, addresses of data to load, or values that are outputs from other work-item executions. In some examples, the data indicates which register is to store a workgroup identifier (which unique identifies a workgroup of a kernel dispatch). More specifically, in some examples, the work dispatch controller 310 spawns workgroups with work-items having at least one register that stores the workgroup identifier. In some such examples, the data (parameters 410) indicates which register is to store the workgroup identifier. In some examples, the parameters 506 also include an indication of which process (e.g., process executing on the processor 102) the workgroup is associated with. More specifically, a process (e.g., a thread) executing on the processor 102 requests work be performed on the APD 116 by sending a command queue to the APD 116. Such a process has a unique identifier. In some examples, the parameters 410 include such an identifier. In various examples, the parameters 410 also includes other information related to execution such as whether the kernel dispatch is participating in encrypted digital rights management, whether the workgroups should begin in debug mode, whether the workgroups should execute in single step mode, whether the workgroups have a trap handler, or other information.

The dispatch flags 508 include an indication of whether to perform on-completion work and an indication of whether to update a command queue pointer upon completion of a kernel dispatch. Regarding the indication of whether to perform on-completion work, this indication indicates whether to perform the on-completion work 510. Regarding the indication of whether to update a command queue pointer upon completion of a kernel dispatch, the purpose of this indication is for context switching. More specifically, a context switch refers to changing which command queue 304 is performing work on the APD 116. In other words, it is possible to fetch from any particular command queue 304 and switching which command queue 304 is being fetched from for the purpose of performing work is referred to as a context switch. Context switches can be based on a time-sharing algorithm that gives particular amounts of time to different command queues 304. The queue switch can occur between queues corresponding to different processes executing on the processor 102 or between different virtual machines. When a context switch occurs, work for one process is stopped and work for another process begins. The command processor 136 maintains pointers into the command queues 304 that indicates the last command queue entry whose kernel dispatch has been completed. When a kernel dispatch is completed for an entry of a command queue 304, the command processor 136 (e.g., the command queue processor 306) updates the pointer for the command queue to point to the next uncompleted entry. The indication of whether to update the command queue is an indication to the command queue processor 306 regarding whether or not to update this pointer. When a context switch occurs, the currently executing kernel dispatch for a first process is removed from the APD 116 and work for a second process begins. When a context switch back to the first process occurs, the command processor 136 examines the pointer to determine which command queue entry 404 to perform work for. Updating this pointer thus allows the command processor 136 to begin at the first uncompleted command queue entry 404 when return to a process after a context switch.

The on-completion work 510 includes an indication of what work is to be performed when the kernel dispatch is completed in the compute units 132. Examples of such work includes notifying the processor 102 (or other entity that generated the corresponding command queue entry) that the kernel dispatch is complete, whether by sending a value to the entity or raising an interrupt. Other processors, such as other APDs 116, network controllers, or other processors can be notified as well. Other examples of on-completion work 510 includes flushing or invalidating caches, taking timestamps, disabling performance monitoring hardware and engaging power saving modes.

In some examples, the work dispatch descriptor entries 502 are separated by a barrier. More specifically, for each new work dispatch descriptor entry 502, the command queue processor 306 inserts a barrier into the work dispatch descriptor queue 308 that indicates the boundary between adjacent work dispatch descriptor entries 502 in the work dispatch descriptor queue 308. In other examples, the command queue processor 306 inserts a size for each work dispatch descriptor entry 502 that indicates how large (e.g., how many bytes) the work dispatch descriptor entry 502 is, so that the work dispatch controller 310 knows the boundary between work dispatch descriptor entries 502. In other examples, each work dispatch descriptor entry 502 is the same size, thus allowing the work dispatch controller 310 know the boundary between such entries 502.

FIG. 6 illustrates the work dispatch controller 310 generating workgroups for the compute units 132. The work dispatch controller 310 examines the work dispatch descriptor entries 502 and generates workgroups in accordance with such entries 502 for execution on the compute units 132. As described above, the kernel dispatch info 504 includes the kernel dispatch size, which indicates how many workgroups to spawn as well as how many work-items to be included with each workgroup. The work dispatch controller 310 generates these workgroups, and is finished doing such generating when the work dispatch controller 310 has generated all requested workgroups. In various examples, generating the workgroups includes reserving registers and/or memory for the workgroups and transmitting information to the compute units 132 indicating that the compute units 132 are to execute the workgroups. Generating the workgroups also includes determining the number of workgroups to be executed, and reserving all required resources for such workgroups, as well as spawning those workgroups. The work dispatch controller 310 generates the workgroups in the manner specified by the work dispatch descriptor entry 502. This includes, for example, generating workgroups in the number specified, each having a specified number of work-items, placing the data specified by the parameters 506 into the registers or local memory specified by the parameters 506, and performing any other actions as specified by the work dispatch descriptor entry 502. If the dispatch flags 508 indicates that on-completion work 510 should be performed, then the work dispatch controller 310 instructs the command queue processor 306 to perform such work (specified in the on-completion work 510) when the kernel dispatch is complete. If the dispatch flags 508 indicates that the command queue pointer should be updated on completion of a kernel dispatch, then the work dispatch controller 310 configures the command queue processor 306 to update the command queue pointer in response to the kernel dispatch being completed. Again, the command queue processor 306 updates this pointer to point to the next uncompleted command queue entry 404 upon completion of the kernel dispatch for the previous command queue entry 404. That is, upon completion of a kernel dispatch corresponding to a command queue entry 404, the command queue processor 306 updates the command queue pointer to point to the next command queue entry 404 (subsequent to the command queue entry 404 for which completion has occurred).

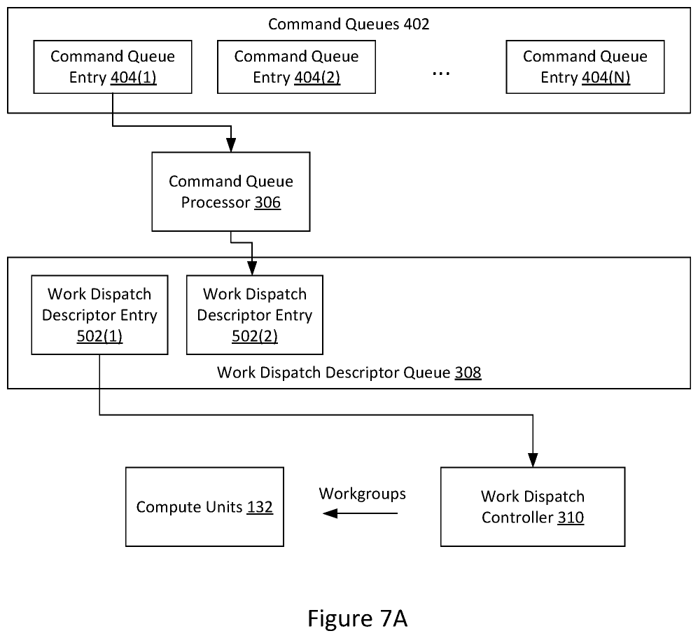

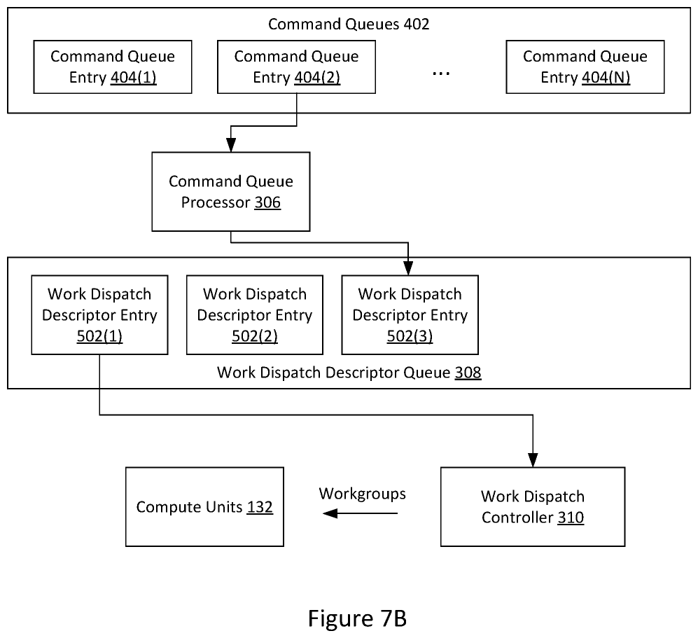

FIGS. 7A-7B illustrate operations for generating workgroups for execution while also writing work dispatch descriptor entries 502 into the work dispatch descriptor queue 308. More specifically, these figures illustrate that it is possible for the command queue processor 306 to work significantly ahead of the work dispatch controller 310. FIG. 7A illustrates a first time period and FIG. 7B illustrates a second, subsequent time period.

As shown in FIG. 7A, in a first time period, the command queue processor 306 is reading the command queue entry 404(1) to generate a work-dispatch descriptor entry 502(2). Note that prior to this time period, the command queue processor 306 already generated the work dispatch descriptor entry 502(1). Also, in this time period, the work dispatch controller 310 is launching workgroups to execute on the compute units 132, based on the previously generated work dispatch descriptor entry 502(2).

In FIG. 7B, depicting a subsequent time period, the command queue processor 306 is processing command queue entry 404(2) to generate work dispatch descriptor entry 502(3). The work dispatch controller 310 is continuing to work on the work dispatch descriptor entry 502(1) during this time period. As can be seen, the command queue processor 306 is capable of “working ahead” of the work dispatch controller 310. It would be possible, for example, for the command queue processor 306 to continue processing command queue entries 404 to generate work dispatch descriptor entries 502, even while the work dispatch controller 310 continues to process the work dispatch descriptor entry 502(1) to generate workgroups for execution on the compute units 132.

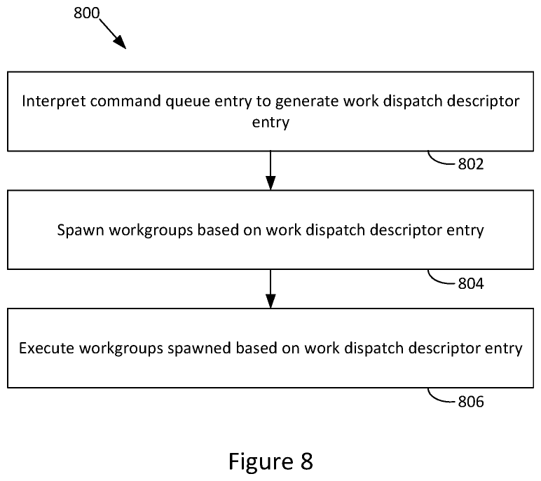

FIG. 8 is a flow diagram of a method 800 for executing compute kernels on an APD 116, according to an example. Although described with respect to the system of FIGS. 1-7B, those of skill in the art will understand that any system configured to perform the steps of the method 800 in any technically feasible order falls within the scope of the present disclosure.

At step 802, a command queue processor 306 interprets a command queue entry 404 to generate a work dispatch descriptor entry 502. More specifically, a command queue entry 404 is placed into a command queue 402 by a processor such as the processor 102 (e.g., a central processing unit (“CPU”)). In some examples, this placement is a result of execution of one or more application programming interface (“API”) function calls on a CPU. The one or more API function calls specify information such as which compute kernel to execute, the “size” of the compute kernel (e.g., how many work items per workgroup and how many workgroups), as well as the parameters (e.g., input data) for the compute kernel, and other information included in the command queue entry 404.

The command queue processor 306 interprets the command queue entry 404, generating the work dispatch descriptor entry 502 in accordance with the command queue entry 404. As described elsewhere herein, the work dispatch descriptor entry 502 includes the kernel dispatch info 504, parameters 506, dispatch flags 508, and on-completion work. The kernel dispatch info 504 includes the code address 406 (which may or may not be in the same form as in the command queue entry 404) and the size of the dispatch, as well as other information as specified elsewhere herein. The command queue processor 306 obtains this information from the command queue entry 404 itself and/or from other sources such as settings data maintained by the APD 116 (e.g., in the command queue processor 306 itself or in another location). The parameters 506 includes the parameters 410 of the command queue entry 404, as well as other parameters such as which register should store a workgroup ID, and other parameters described elsewhere herein. The dispatch flags 508 include an indication of whether to perform on-completion work 510 and whether to update the command queue pointer. The command queue processor 306 obtains this information from the command queue entry 404 itself and/or from configuration data previously set in the APD 116 (such as in the command queue processor 306). The on-completion work 510 includes work to be performed after completion of the kernel dispatch and includes information specified by one or both of the command queue entry 404 and previously set configuration information.

At step 804, the work dispatch controller 310 spawns workgroups based on a work dispatch descriptor entry 502. More specifically, the work dispatch controller 310 generates the workgroups. This generating includes creating data structures necessary for workgroup execution, reserving resources such as registers and local memory, and instructing the compute units 132 to perform the workgroups. In various examples, generating the workgroups includes determining how many workgroups to launch and what hardware (e.g., compute unit 132) is to execute those workgroups, sending initialization data to that hardware to initialize the state of the workgroup, where the initialization data includes arguments, thread number, register size, process identifier, floating point exception state, and the like, and initializing values for execution of the workgroups such as workgroup ID.

At step 806, the compute units 132 execute the spawned workgroups, based on the manner in which those workgroups were created. For a kernel dispatch (corresponding to one command queue entry 404 and one work dispatch descriptor entry 502), the compute units 132 execute the number of workgroups specified by the work dispatch descriptor entry 502. The compute units 132 also execute the workgroups with the other parameters and execution modes specified by the work dispatch descriptor entry 502. Upon completion of the kernel dispatch, if the dispatch flags 508 indicate that the on-completion work 510 is to be performed on completion of the kernel dispatch, then the command queue processor 306 (or other unit of the command processor 136) performs the specified on-completion work 510. If the dispatch flags 508 indicate that the command queue pointer should be updated upon completion of the kernel dispatch, then upon completion of the kernel dispatch in the compute units 132, the command processor 136 updates the command queue pointer as described elsewhere herein.

As stated elsewhere, the generation of the work dispatch descriptor entries can occur asynchronously with spawning the workgroups based on the work dispatch descriptor entries. In other words, while the work dispatch controller 310 is generating workgroups for one work dispatch descriptor entry 502, it is possible for command queue processor 306 to be generating one or more subsequent work dispatch descriptor entries 502.

It is possible for a processor such as the processor 102 to configure the manner in which the command queue processor 306 generates the work dispatch descriptor entries 502. More specifically, in some examples, the processor 102 can configure how any of the information that gets written into a work dispatch descriptor entry 502 (even where not specified by a corresponding command queue entry 404).

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, command generator 302, and command processor 136 (including the command queue processor 306 and work dispatch controller 310), are implemented fully in hardware, fully in software executing on processing units, or as a combination thereof. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
fetching a command queue entry that specifies work to be executed on a device;
generating a work dispatch descriptor entry based on the command queue entry; and
spawning workgroups based on the work dispatch descriptor entry.

2. The method of claim 1, wherein the command queue entry includes a code address for a compute kernel, a dispatch size, and parameters for execution.

3. The method of claim 1, wherein generating the work dispatch descriptor entry is based on contents of the command queue entry and configuration data.

4. The method of claim 1, wherein the work dispatch descriptor entry includes kernel dispatch information, parameters, dispatch flags, and on-completion work.

5. The method of claim 1, further comprising storing work dispatch descriptor entries in a queue.

6. The method of claim 5, wherein the spawning occurs at different rates than the rate of placement of the work dispatch descriptor entries into the queue.

7. The method of claim 1, further comprising generating one or more additional work dispatch descriptor entries while spawning and executing workgroups based on the work dispatch descriptor entry.

8. The method of claim 4, wherein the on-completion work includes work to be performed upon completion of a kernel dispatch associated with the work dispatch descriptor entry.

9. The method of claim 1, wherein the command queue entry is generated by an application programming interface function call.

10. A system comprising:
a memory configured to store command queue entries; and
a processor configured to:
fetch a command queue entry from the memory that specifies work to be executed on a device;
generate a work dispatch descriptor entry based on the command queue entry; and
spawn workgroups based on the work dispatch descriptor entry.

11. The system of claim 10, wherein the command queue entry includes a code address for a compute kernel, a dispatch size, and parameters for execution.

12. The system of claim 10, wherein generating the work dispatch descriptor entry is based on contents of the command queue entry and configuration data.

13. The system of claim 10, wherein the work dispatch descriptor entry includes kernel dispatch information, parameters, dispatch flags, and on-completion work.

14. The system of claim 10, wherein the processor is further configured to store work dispatch descriptor entries in a queue.

15. The system of claim 14, wherein the spawning occurs at different rates than the rate of placement of the work dispatch descriptor entries into the queue.

16. The system of claim 10, wherein the processor is further configured to generate one or more additional work dispatch descriptor entries while spawning and executing workgroups based on the work dispatch descriptor entry.

17. The system of claim 13, wherein the on-completion work includes work to be performed upon completion of a kernel dispatch associated with the work dispatch descriptor entry.

18. The system of claim 10, wherein the command queue entry is generated by an application programming interface function call.

19. A non-transitory computer-readable medium storing instructions that, when executed by a processor, cause the processor to perform operations comprising:
fetching a command queue entry that specifies work to be executed on a device;
generating a work dispatch descriptor entry based on the command queue entry; and
spawning workgroups based on the work dispatch descriptor entry.

20. The non-transitory computer-readable medium of claim 19, wherein the command queue entry includes a code address for a compute kernel, a dispatch size, and parameters for execution.
